(19) United States
(12) Patent Application Publication
(10) Pub. No.: US 2005/0282557 A1
(43) Pub. Date: Dec. 22, 2005

(54) System and method for implementing a remote location acquisition application program interface

(75) Inventors: Blomqvist Mikko, Tampere (FI); Petri Rauhala, Tampere (FI); Tommi Laine, Tempere (FI)

Correspondence Address: FOLEY & LARDNER, 321 NORTH CLARK STREET, SUITE 2800, CHICAGO, IL, 60610-4764, US

(73) Assignee: Nokia Corporation, NOKIA GROUP (FI)

(21) Appl. No.: 10/870,335

(22) Filed: Jun. 17, 2004

(51) Int. Cl. H04Q 7/20

(52) U.S. Cl. 455/456.1; 455/456.2; 455/456.3

(57) ABSTRACT

An Application Program Interface (API) is defined at a requesting terminal. The API provides a common interface between an application program requesting a location for a target mobile terminal and a location server at the requesting terminal. The location server may be integrated into the API or may be a separate entity. The application program executing on the requesting terminal sends a request through the API for the location of the target mobile terminal. Thus, the API hides the positioning technology details and complexities from the requesting application program. The API communicates with a location determining source that determines the location of the target mobile terminal. The location determining source may be the target mobile terminal. Alternatively, the location determining source may be a network location server such as a Gateway Mobile Location Center or Mobile Positioning Center.

### FIELD OF THE INVENTION

The present invention is related to software applications. More particularly, the present invention relates to an application program interface developed to provide an interface for determining the location of devices.

### BACKGROUND OF THE INVENTION

An application program provides computing devices with the capability to perform a wide variety of tasks including drafting documents, communicating with others, preparing presentations, locating information, etc. An application program is an organized list of instructions that, when executed, cause the computer to behave in a predetermined manner. Processing to prepare an application program for execution may include the use of an assembler, a compiler, an interpreter, or a translator depending on the implementation language.

An Application Program Interface (API) is a formalized set of software calls and routines that can be referenced by an application program in order to access the supporting system or network services. The API is the specific method prescribed by a computer operating system or by an application program by which a programmer in writing an application program makes requests of the operating system or of another application program. The API generally also receives requests from the operating system or another application program and routes these requests to the appropriate application program.

The operating system is the low-level software installed on a computer to handle the interface to peripheral hardware, to schedule tasks, to allocate memory, and to present a default interface to the user when no application program is running. The kernel is the core part of the operating system that is responsible for resource allocation, for low-level hardware interfacing, for security, etc. The operating system makes the resources available to application programs using functions collectively known as the API. The functions are often grouped in terms of what resource or service is provided to the application programmer. Thus, for example, an API may be directed to the computing systems security services. For example, the Security Services API provides application programmers with uniform access to security services atop a variety of underlying cryptographic mechanisms by providing a layer of abstraction over security mechanisms that perform authentication, message integrity protection, and message privacy protection.

Application programs request resources by calling individual API functions. API functions also serve as the means by which messages and information provided by the operating system are relayed back to the application program. The API is defined at the source code level and provides a level of abstraction between the application program and the kernel or other application programs to ensure the portability of the code from one machine to another, and thus, provide platform independence. An API can also provide an interface between a high level language and lower level utilities and services that were written without consideration for the calling conventions supported by the high level language. In this case, the API's main task may be the translation of parameter lists from one format to another and the interpretation of call-by-value and call-by-reference arguments in one or both directions. The calling convention is the arrangement of arguments for a procedure or function call such that the data transferred through the interface maps to the proper parameter. Different programming languages may require arguments to be pushed onto a stack or entered in registers in left-to-right or right-to left order, and either the caller or the callee may be responsible for removing the arguments from the stack or register in the proper sequence. The calling convention also determines if a variable number of arguments is allowed.

The API provides common functionality to satisfy specific underlying needs. Use of an API reduces the programming time and increases the reliability of application programs by providing a common interface to what may be an unknown operating system or application program to which the API interfaces. Thus, an API hides complexities from and provides portability and broader use of application programs across different computing devices with different software and hardware configurations.

Application programs have been developed that allow a request for the current location of a mobile terminal by another computing device. Application programs have also been developed that allow a mobile terminal to request its current location. These applications may, for example, request accurate, real-time positioning of the mobile terminal itself in order to connect the terminal user to nearby points of interest, to advise them of current traffic or weather conditions, or to provide routing information. Additionally, applications related to fleet management such as in the trucking, delivery, and taxi business areas need to determine the location of multiple mobile terminals and provide this information to another computing device. Additionally, applications supporting emergency services have been developed that require a determination of a location for a mobile terminal.

Various methods have been developed for determining the location of the mobile terminal. For example, some mobile terminals may include a Global Positioning System (GPS) as part of the device. The GPS uses satellites to triangulate to the location of the GPS. Alternatively, other methods utilize a ground based network of antennas or base stations to determine the mobile terminal location. For example, an application program might make a request to a wireless carrier network. The wireless carrier would then use one of several methods to determine a user's location on the wireless network and return the latitude and longitude coordinates to the application program. One method involves identifying the cell or base station closest to the mobile terminal. The antenna in communications with the mobile terminal may then be used to determine the relative direction of the mobile terminal. Using the round trip time, the distance from the base station can be determined providing an location with an accuracy approaching 100 meters. Another method using multiple base stations may be used in some circumstances. The location of the mobile terminal can be determined using typically three base stations capable of communicating with the mobile terminal and triangulating the estimated location of the mobile terminal from each individual base station. More precise location estimates approaching 30 meters can be achieved using this method.

The location methods fall into three primary categories: network overlay, handset enhanced, and enhanced cell ID. The methods that a specific carrier implements depend on the level of accuracy required, the network technology, and the existing infrastructure. Newer networks and mobile terminals have capabilities that do not exist on legacy systems. There are several network based positioning technologies such as Time of Arrival (TOA) that provides triangulation of a mobile terminal's position based on the speed at which a user is moving away from or toward various base stations. This technology is primarily for legacy mobile terminal support and provides accuracy within about 300 meters. Other network based positioning technologies are the Enhanced Observed Time Difference (E-OTD) which requires additional mobile terminal capabilities (e.g., device processing) to locate a mobile terminal's position based on triangulation. E-OTD location methods provide accuracy within about 50 to 100 meters. Enhanced cell ID is another example of a network based positioning technology. It uses methods of enhancing current cell ID technologies to improve accuracy. These enhancements include Receiver cell signal (RX) strength. Enhanced cell ID methods provide accuracy within about 1000 meters. Network assisted positioning technologies include for example Network assisted GPS, where the network provides the terminal with assistance data for the GPS which may be connected to the terminal or integrated with the terminal. For example, “time to first fix” and indoor coverage can be improved with the assistance data. A traditional GPS device provides an example of handset stand-alone positioning technology where the traditional GPS has been enhanced with communication capabilities.

Wireless carriers implement and manage servers according to American National Standards Institute (ANSI), Global System for Mobile Communications (GSM), and Universal Mobile Telecommunications System (UMTS) standards that are designed to calculate the location of mobiles terminals that are connected to the network. These servers, commonly known as network location servers, have different implementations depending on the wireless standard. For GSM and UMTS, the network location server is known as the Gateway Mobile Location Center (GMLC), and, in ANSI standards, it is called the Mobile Positioning Center (MPC). Functionally, GMLC and MPC are the same. The network location server is the software platform that provides the location information by implementing the above-mentioned location determination methods. The network location servers determine a mobile terminal's location using specific and often proprietary methods, and then communicate this information using different data protocols. Using enhanced handsets or GPS enabled handsets, the mobile terminal itself may provide the location information.

The development of application programs that require location information is challenged by the disparate location technologies implemented by various wireless carriers, service providers, and equipment vendors. In particular, the question of how wireless carriers and service providers will implement and utilize their different location infrastructures results in many answers depending upon to whom the question is addressed. As a result, developers of these types of application programs must support multiple, disparate location determination technologies, a wide variety of geo-spatial and content implementations (for example, the coordinate system used and the accuracy of the calculation), and multiple data transport protocols.

What is needed is an API to hide the implementation details of the location determination technologies from an application program executing at a requesting mobile terminal that requests a location determination for a target mobile terminal. Further, there is a need for an API implemented at the requesting mobile terminal.

### SUMMARY OF THE INVENTION

An exemplary embodiment of the invention relates to a method of providing a mobile terminal location. The method comprises providing a location for a target mobile terminal in an application program interface (API) executing at a requesting terminal.

Another exemplary embodiment of the invention relates to a method of providing a mobile terminal location. The method comprises receiving a request for a location of a target mobile terminal from an application program in an application program interface (API) at a requesting mobile terminal, selecting a location determining source in the API to determine the location of the target mobile terminal, communicating the request from the API to the selected location determining source, determining the location of the target mobile terminal, receiving the location of the target mobile terminal at the API in the requesting terminal, and providing the location of the target mobile terminal to an application program from the API.

The request from the API to the selected location determining source may be communicated using a messaging service such as a short messaging service, a multimedia messaging service, an Instant Messaging service, etc., or a protocol such as an Internet protocol, a Hyper-Text Transfer Protocol, etc. The API may provide, but is not limited to, a protocol to receive the request from the application program, a protocol to send the request to the location determining source, a protocol to receive the location from the location determining source, and a protocol to send the location to the application program. The location determining source may be, but is not limited to, any of the target mobile terminal and a network location server. The network location server may be, but is not limited to, any of a gateway mobile location center and a mobile positioning center. The request may be sent using a wireless network, a cellular telephone network, the Internet, etc. in combination or in the alternative.

Still another exemplary embodiment of the invention relates to an application program interface (API) for providing a mobile terminal location. The API comprises computer code configured to receive a request for a location of a target mobile terminal from an application program, select a location determining source to determine the location of the target mobile terminal, communicate the request to the selected location determining source, receive the location of the target mobile terminal, and send the location to the application program.

The request from the API to the selected location determining source may be communicated using a messaging service such as a short messaging service, a multimedia messaging service, an Instant Messaging service, etc., or a protocol such as an Internet protocol, a Hyper-Text Transfer Protocol, etc. The computer code may be further configured to provide a protocol to receive the request from the application program, to provide a protocol to send the request to the location determining source, to provide a protocol to receive the location from the location determining source, and/or to provide a protocol to send the location to the application program. The location determining source may be, but is not limited to, any of the target mobile terminal and a network location server. The network location server may be, but is not limited to, any of a gateway mobile location center and a mobile positioning center. The request may be sent using a wireless network, a cellular telephone network, the Internet, etc. in combination or in the alternative.

Still another exemplary embodiment of the invention relates to a device for providing a mobile terminal location. The device comprises a processor, an application program interface (API), and a communication interface. The processor couples to the communication interface and executes an application program and the API. The API comprises computer code configured to receive a request for a location of a target mobile terminal from an application program, select a location determining source to determine the location of the target mobile terminal, communicate the request to the selected location determining source, receive the location of the target mobile terminal, and send the location to the application program. The communication interface is configured to send the request to the selected location determining source and to receive the location of the target mobile terminal.

The request from the API to the selected location determining source may be communicated using a messaging service such as a short messaging service, a multimedia messaging service, an Instant Messaging service, etc., or a protocol such as an Internet protocol, a Hyper-Text Transfer Protocol, etc. The computer code of the API may be further configured to provide a protocol to receive the request from the application program, to provide a protocol to send the request to the location determining source, to provide a protocol to receive the location from the location determining source, and/or to provide a protocol to send the location to the application program. The location determining source may be, but is not limited to, any of the target mobile terminal and a network location server. The network location server may be, but is not limited to, any of a gateway mobile location center and a mobile positioning center. The request may be sent using a wireless network, a cellular telephone network, the Internet, etc. in combination or in the alternative.

Still another exemplary embodiment of the invention relates to a system for providing a mobile terminal location. The system comprises a requesting terminal and a location determining source. The requesting mobile terminal comprises a processor, an application program interface (API), and a communication interface. The processor couples to the communication interface and executes an application program and the API. The API comprises computer code configured to receive a request for a location of a target mobile terminal from an application program, select a location determining source to determine the location of the target mobile terminal, communicate the request to the selected location determining source, receive the location of the target mobile terminal, and send the location to the application program. The communication interface is configured to send the request to the selected location determining source and to receive the location of the target mobile terminal. The location determining source receives the request for the location of the target mobile terminal, determines the location of the target mobile terminal, and sends the location to the requesting terminal.

The request from the API to the selected location determining source may be communicated using a messaging service such as a short messaging service, a multimedia messaging service, an Instant Messaging service, etc., or a protocol such as an Internet protocol, a Hyper-Text Transfer Protocol, etc. The computer code of the API may be further configured to provide a protocol to receive the request from the application program, to provide a protocol to send the request to the location determining source, to provide a protocol to receive the location from the location determining source, and/or to provide a protocol to send the location to the application program. The location determining source may be, but is not limited to, any of the target mobile terminal and a network location server. The network location server may be, but is not limited to, any of a gateway mobile location center and a mobile positioning center. The request may be sent using a wireless network, a cellular telephone network, the Internet, etc. in combination or in the alternative.

Other principal features and advantages of the invention will become apparent to those skilled in the art upon review of the following drawings, the detailed description, and the appended claims.

### BRIEF DESCRIPTION OF THE DRAWINGS

The exemplary embodiments will hereafter be described with reference to the accompanying drawings, wherein like numerals will denote like elements.

FIG. 1 is an overview diagram of a telecommunications system in accordance with an exemplary embodiment.

FIG. 2 is an overview diagram of a device in accordance with an exemplary embodiment.

FIG. 3 is a overview diagram of an exemplary embodiment showing the communication between devices.

FIG. 4 is a overview diagram of an alternative embodiment showing the communication between devices wherein the target mobile terminal is a legacy terminal.

### DETAILED DESCRIPTION OF THE PREFERRED EMBODIMENTS

The term “terminal” should be understood to include, without limitation, cellular telephones, Personal Data Assistants (PDAs), such as those manufactured by PALM, Inc., Instant Messaging Devices (IMD), such as those manufactured by Blackberry, Inc., Bluetooth Devices such as Bluetooth GPS, and other hand-held devices; notebook computers; laptop computers; desktop computers; mainframe computers; multi-processor systems; Bluetooth Beacons, etc. The term “mobile terminal” should be understood to include, without limitation, cellular telephones; PDAs and IMDs with telephonic or wireless communication capabilities, notebook and laptop computers with telephonic or wireless communication capabilities; and other mobile devices that can communicate using various transmission technologies (including Code Division Multiple Access, GSM, UMTS, Time Division Multiple Access, and others) or media (radio, infrared, laser, and the like).

An API provides a level of abstraction between the application and the kernel or other application programs and lower level utilities and services that facilitates the portability of the software from one computing device to another. The API is used by a programmer in writing an application program to define the interface to the operating system or another application program or system service without needing to understand the details of the operating system, application program, or system service. These elements may be implemented in different forms, but the programmer need only be concerned with the interface. Thus, the programmer focuses on the information that is required as an input to the API and the information that is output from the API.

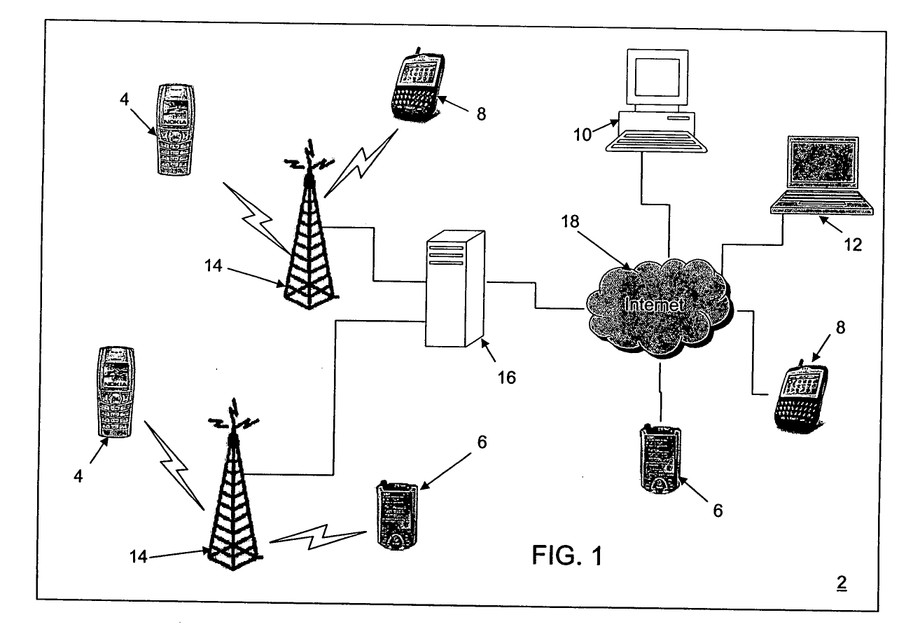

With reference to FIG. 1, the system 2 is comprised of multiple terminals that are connected through a network that may include, but is not limited to, a cellular telephone network and the Internet. The terminals may include, but are not limited to, a cellular telephone 4, a PDA 6, an IMD 8, a desktop computer 10, and a notebook computer 12. Mobile terminals may include, but are not limited to, a cellular telephone 4, a PDA 6, an IMD 8, and a notebook computer 10. The mobile terminals may be stationary or moving as when carried by an individual who is moving. The mobile terminals may also be located in a mode of transportation including, but not limited to, an automobile, a truck, a taxi, a bus, a boat, an airplane, a bicycle, a motorcycle, etc. The mobile terminals may send and receive calls and messages through the base station 14. The network server 16 allows communication between the mobile terminals and other terminals that may also be mobile. The network server 16 may connect the mobile terminals with other terminals through the Internet 18.

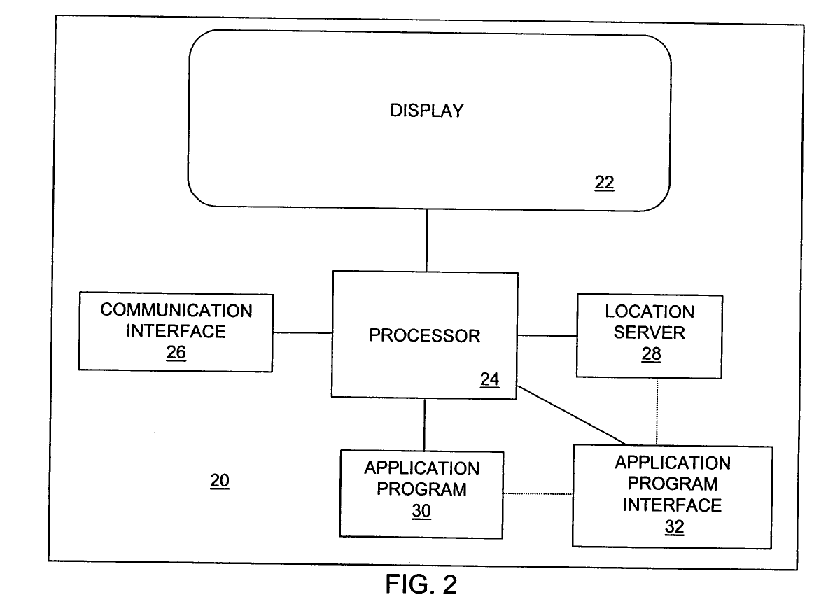

In a preferred embodiment, the mobile terminal 20, as shown in FIG. 2, comprises a display 22, a processor 24, a communication interface 26, a location server 28, an application program 30, and an API 32. The exact architecture of the mobile terminal 20 is not important. Different and additional mobile terminal compatible devices may be incorporated into the mobile terminal 20 and/or the system 2 as long as the location server 28 and API 32 can be implemented on the mobile terminal 20 as described below.

The display 22 presents information for display and for editing including information generated by the application program 30. The display 22 can be a thin film transistor (TFT) display, a light emitting diode (LED) display, a Liquid Crystal Display (LCD), or any of a variety of different displays known to those skilled in the art.

The processor 24 executes instructions from the application program 30, the API 32, and the location server 28 in addition to other instructions contained within the processor 24. Application programs are open for execution after a user requests that the mobile terminal 20 launch the application program. Launching the application generally requires copying an executable for the application program 30 from a permanent memory device to system memory that is generally some form of random access memory. A terminal user executes an application program 30 by selecting the application for launch. The system memory holds the operating system and application programs 30 and data in current use so that they can be reached quickly by the computer's processor. The application programs 30, the API 32, and the location server 28 may be executed by the same processor 24. Alternatively, the application programs 30, the API 32, and the location server 28 may be executed by different processors. The application programs 30, the API 32, and the location server 28 may be written in the same or different computer languages including, but not limited to high level languages, scripting languages, and assembly languages, etc. Additionally, the application program 30, the API 32, and the location server 28 operations may be carried out by a special purpose computer, logic circuits, or hardware circuits. Thus, the application program 30, the API 32, and the location server 28 may be implemented in hardware, firmware, software, or any combination of these methods.

The communication interface 26 provides an interface for receiving and transmitting calls, messages, and any other information communicable across a network. Communications between a terminal and a mobile terminal may be through one or more of the following connection methods, without limitation: a link established according to the Bluetooth Standards and Protocols, an infrared communications link, a wireless communications link, a cellular network link, a physical serial connection, a physical parallel connection, a link established according to the Transmission Control Protocol/Internet Protocol and Standards (TCP/IP), etc. Other connection methods may be used. Transferring content between mobile terminal may use one or more of these connection types.

Text messaging services provided for mobile terminals include, but are not limited to, the Short Messaging Service (SMS) and the Multimedia Messaging Service (MMS). SMS is a mechanism for delivering short messages over communication networks. SMS is a store and forward method of transmitting messages to and from mobiles terminals and has become an essentially universal mobile data service. Communicating messages between mobile terminals may use messaging services provided for mobile terminals including, but not limited to, SMS, MMS, e-mail, Instant Messaging (IM), and TCP/IP. SMS for transferring content may be used in preferred embodiments due to the low overhead of such messages. Other communication message formats and transmission protocols may be used.

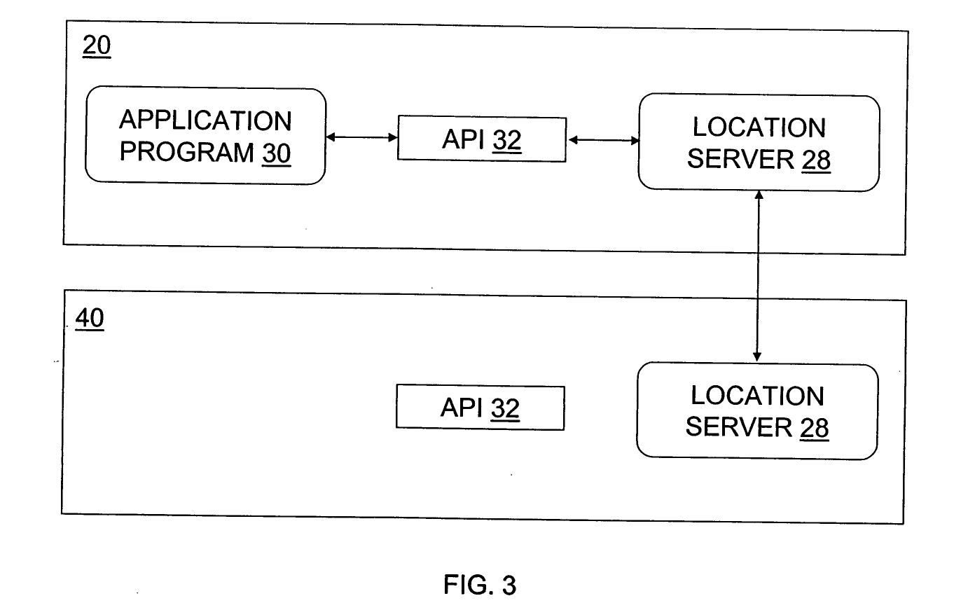

FIG. 3 depicts a preferred mobile terminal 20 comprising the application program 30, the API 32, and the location server 28. The application program 30 instruction set was implemented using the API 32 as an interface for acquiring location information for a target mobile terminal 40. The application program 30 sends a request through the API 32 for a location of the target mobile terminal 40. Thus, the API 32 is located in the mobile terminal 20 that requests the location of the target mobile terminal 40. The request from the application program 30 may identify the target mobile terminal 40 using, for example, a phone number, an IP address, a name, or other similar identification mechanisms. The method used to identify the location may depend upon the application program 30 requirements. The API 32 receives and processes the request for the location and sends the request to the location server 28. The API 32 may be provided as part of the location server 28 implementation or may be implemented separately. In either case, the location server 28 instruction set is implemented using the API 32 as an interface. The location server 28 receives the location request and communicates the location request to the mobile terminal 40 through the communication interface 26. The location server 28 may keep a list of the received location information or may store the location information on another element networked to the mobile terminal 20.

In a preferred embodiment as shown in FIG. 3, the target mobile terminal 40 also comprises the location server 28 and API 32. The location server 28 at the target mobile terminal 40 receives the communicated location request and determines the location of the target mobile terminal 40 using positioning technologies known by those skilled in the art. The location server 28 at the target mobile terminal 40 sends the location of the target mobile terminal 40 to the location server 28 at the requesting mobile terminal 20. The location server 28 at the requesting mobile terminal 20 receives the location and sends the location to the API 32 at the requesting mobile terminal 20. The API 32 receives the location and sends the location to the application program 30. The API 32 provides protocols for processing the request from the application program 30, for sending the request to the target mobile terminal 40, for receiving the location from the target mobile terminal 40, and for sending the location to the application program 30.

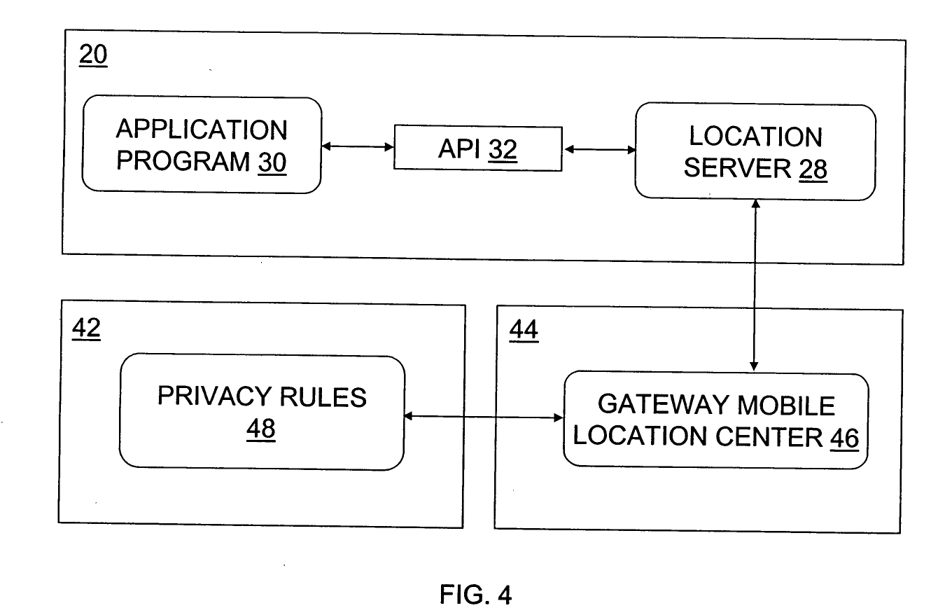

FIG. 4 depicts an alternative embodiment. The mobile terminal 20 again comprises the application program 30, the API 32, and the location server 28. The application program 30 instruction set was implemented using the API 32 as an interface for acquiring location information for a target mobile terminal 42. The application program 30 sends a request through the API 32 for a location of the mobile terminal 42. The location request may identify the target mobile terminal 42 using, for example, a phone number, an IP address, a name, or other similar identification mechanisms. The API 32 receives and handles the location request and sends the request to the location server 28. The API 32 may be provided as part of the location server 28 implementation or may be implemented separately. In either case, the location server 28 instruction set was implemented using the API 32 as an interface. The location server 28 receives the location request and communicates the location request to a network location server 44. The network location server 44 determines the location of the target mobile terminal 42. Example network location servers include the GMLC and the MPC. Functionally, the GMLC and the MPC are the same. The network location server 44 is the software platform that provides the location information by implementing any of the above-mentioned location determination methods or any other location determination methods known to those skilled in the art or to be developed. The example alternative embodiment of FIG. 4 depicts a GMLC 46 as the network location server 44.

In the alternative embodiment in FIG. 4, the target mobile terminal 42 may be a legacy terminal that does not include the location server 28, but includes privacy rules 48 that allow or deny a request for the location of the target mobile terminal 42. Instead of communicating the request to the location server 28 at the target mobile terminal 40, the communication is sent to the GMLC 46. If the request for the location is allowed by the privacy rules 48, GMLC 46 executes, for example, a Mobile Terminated Location Request (MT-LR) procedure, as is known in the art, to determine the target mobile terminal 42 location. The GMLC 46 resides in the mobile terminal network. The GMLC 46 sends the location of the target mobile terminal 42 to the location server 28 at the requesting mobile terminal 20. The location server 28 at the requesting mobile terminal 20 receives the location and sends the location to the API 32 at the requesting mobile terminal 20. The API 32 receives the location and sends the location to the application program 30.

The API disclosed enables a mobile terminal to request a location of a target mobile terminal. In doing so, the API hides all of the positioning technology details from the application program that requests the location. By doing so, the API reduces the complexity and enhances the portability of application programs and provides increased reliability. As a result, the API resolves the problems encountered by application developers concerning the multiple, disparate location determination technologies, the wide variety of geo-spatial and content implementations, and the multiple data transport protocols. Resolving these issues encourages the development of application programs for mobile terminals that require such location information. An example application program locates friends or family members. A parent, using such an application program, could then locate their child on a map when the child carries the mobile terminal.

It is understood that the invention is not confined to the particular embodiments set forth herein as illustrative, but embraces all such modifications, combinations, and permutations as come within the scope of the following claims. The present invention is not limited to a particular operating environment. Those skilled in the art will recognize that the system and methods of the present invention may be advantageously operated on different platforms. Thus, the description of the preferred embodiments is for purposes of illustration and not limitation.

1. A method of providing a mobile terminal location, the method comprising providing a location for a target mobile terminal in an application program interface (API) executing at a requesting terminal.

2. A method of providing a mobile terminal location, the method comprising:
receiving a request for a location of a target mobile terminal from an application program in an application program interface (API) at a requesting mobile terminal;
selecting a location determining source in the API to determine the location of the target mobile terminal;
communicating the request from the API to the selected location determining source;
determining the location of the target mobile terminal;
receiving the location of the target mobile terminal at the API in the requesting terminal; and
providing the location of the target mobile terminal to an application program from the API.

3. The method of claim 2, wherein communicating the request from the API to the selected location determining source uses a messaging service.

4. The method of claim 3, wherein the messaging service is a short messaging service.

5. The method of claim 3, wherein the messaging service is a multimedia messaging service.

6. The method of claim 3, wherein the messaging service is an instant messaging service.

7. The method of claim 2, wherein communicating the request from the API to the selected location determining source uses a protocol.

8. The method of claim 7, wherein the protocol is an Internet protocol.

9. The method of claim 7, wherein the protocol is a hyper-text transfer protocol.

10. The method of claim 2, wherein the API provides a protocol to receive the request from the application program.

11. The method of claim 2, wherein the API provides a protocol to send the request to the location determining source.

12. The method of claim 2, wherein the API provides a protocol to receive the location from the location determining source.

13. The method of claim 2, wherein the API provides a protocol to send the location to the application program.

14. The method of claim 2, wherein the location determining source is the target mobile terminal.

15. The method of claim 2, wherein the location determining source is a network location server.

16. The method of claim 15, wherein the network location server is a gateway mobile location center.

17. The method of claim 15, wherein the network location server is a mobile positioning center.

18. The method of claim 2, wherein the request is sent using a wireless network.

19. The method of claim 2, wherein the request is sent using a cellular telephone network.

20. The method of claim 2, wherein the request is sent using the Internet.

21. An application program interface for providing a mobile terminal location comprising:
computer code configured to:
receive a request for a location of a target mobile terminal from an application program;
select a location determining source to determine the location of the target mobile terminal;
communicate the request to the selected location determining source;
receive the location of the target mobile terminal; and
send the location to the application program.

22. A device for providing a mobile terminal location, the device comprising:
a processor, coupled to a communication interface, that executes an application program and an application program interface (API);
the API, wherein the API comprises computer code configured to:
receive a request for a location of a target mobile terminal from the application program;
select a location determining source to determine the location of the target mobile terminal;
communicate the request to the selected location determining source;
receive the location of the target mobile terminal; and
send the location to the application program; and
the communication interface, wherein the communication interface is configured to:
send the request to the selected location determining source; and
receive the location of the target mobile terminal using the network.

23. The device of claim 22, wherein the computer code of the API communicates the request to the selected location determining source using a messaging service.

24. The device of claim 23, wherein the messaging service is a short messaging service.

25. The device of claim 23, wherein the messaging service is a multimedia messaging service.

26. The device of claim 23, wherein the messaging service is an instant messaging service.

27. The device of claim 22, wherein the computer code of the API communicates the request to the selected location determining source using a protocol.

28. The device of claim 27, wherein the protocol is an Internet protocol.

29. The device of claim 27, wherein the protocol is a hyper-text transfer protocol.

30. The device of claim 22, wherein the computer code of the API is further configured to provide a protocol to receive the request from the application program.

31. The device of claim 22, wherein the computer code of the API is further configured to provide a protocol to send the request to the location determining source.

32. The device of claim 22, wherein the computer code of the API is further configured to provide a protocol to receive the location from the location determining source.

33. The device of claim 22, wherein the computer code of the API is further configured to provide a protocol to send the location to the application program.

34. The device of claim 22, wherein the location determining source is the target mobile terminal.

35. The device of claim 22, wherein the location determining source is a network location server.

36. The device of claim 35, wherein the network location server is a gateway mobile location center.

37. The device of claim 35, wherein the network location server is a mobile positioning center.

38. The device of claim 22, wherein the request is sent using a wireless network.

39. The device of claim 22, wherein the request is sent using a cellular telephone network.

40. The device of claim 22, wherein the request is sent using the Internet.

41. A system for providing a mobile terminal location, the system comprising:
a requesting terminal comprising:
a processor, coupled to a communication interface, that executes an application program and an application program interface (API);
the API, wherein the API comprises computer code configured to:
receive a request for a location of a target mobile terminal from the application program;
select a location determining source to determine the location of the target mobile terminal;
communicate the request to the selected location determining source;
receive the location of the target mobile terminal; and
send the location to the application program; and
the communication interface, wherein the communication interface is configured to:
send the request to the selected location determining source; and
receive the location of the target mobile terminal; and
the location determining source is configured to:
receive the request for the location of the target mobile terminal;
determine the location of the target mobile terminal; and
send the location to the requesting terminal.
